(19) United States
(12) Patent Application Publication
(10) Pub. No.: US 2024/0044186 A1
(43) Pub. Date: Feb. 8, 2024

(54) MOTOR VEHICLE LOCK

(71) Applicant: Pressan Madeni Esya San. Tic. A.S., Istanbul (TR)

(72) Inventors: Buelent Bilgincan, Istanbul (TR); Izzet Durugoenuel, Istanbul (TR)

(21) Appl. No.: 18/268,759

(22) PCT Filed: Dec. 23, 2020
(86) PCT No.: PCT/EP2020/087820

§ 371 Date: Jun. 21, 2023

(51) Int. Cl. E05B 83/24; E05B 85/26

(52) U.S. Cl. CPC E05B 83/24; E05B 85/26

(57) ABSTRACT

A motor vehicle lock, such as for a motor vehicle front hood, comprising a detent mechanism with a catch and a pawl, wherein the pawl is pivotable between a primary blocking position in which the pawl may block the catch in the primary closed position, a secondary blocking position, in which the pawl may block the catch in the secondary closed position, and a release position to release the catch, wherein the motor vehicle lock comprises an actuation lever, which actuation, when the pawl is in the primary blocking position, leads to the actuation lever lifting the pawl such that the catch is released from the primary closed position and the pawl reaches the secondary blocking position to block the catch in the secondary closed position, and which actuation, when the pawl is in the secondary blocking position, leads to the actuation lever lifting the pawl to the release position.

### CROSS-REFERENCE TO RELATED APPLICATIONS

This application is a national stage application under 35 U.S.C. 371 of International Patent Application Serial No. PCT/EP2020/087820, entitled “Motor Vehicle Lock,” filed Dec. 23, 2020, the disclosure of which is incorporated herein by reference.

### FIELD OF THE TECHNOLOGY

Various embodiments relate to a motor vehicle lock and to a motor vehicle.

### SUMMARY

While the motor vehicle lock in question may in principle be assigned to any kind of closing element of a motor vehicle, such as a liftgate, a trunk lid, a back door, a side door or the like, it can be that the motor vehicle lock is configured for a motor vehicle front hood.

The motor vehicle lock in question comprises a detent mechanism with a catch and a pawl, wherein the catch is pivotable between an open position, a primary closed position and a secondary closed position, which is situated between the open position and the primary closed position. The pawl is pivotable between a primary blocking position, in which the pawl may block the catch in the primary closed position, a secondary blocking position, in which the pawl may block the catch in the secondary closed position, and a release position to release the catch. The secondary closed position may correspond to a position of the motor vehicle lock in which the front hood may be partially lifted with respect to a fully closed position of the front hood, while the front hood is still secured by the motor vehicle lock. The front hood is fully released by bringing the catch from the secondary closed position into the open position.

The known motor vehicle lock (EP 2 820 214 B1), which is the starting point of some embodiments, comprises an actuation lever, which actuation, when the pawl is in the primary blocking position, leads to the actuation lever lifting the pawl such that the catch is released from the primary closed position and is brought into the secondary closed position. Another actuation of the actuation lever, when the pawl is in the secondary blocking position, leads to the actuation lever lifting the pawl to the release position. The motor vehicle lock, therefore, provides a double-pull functionality, wherein the user has to perform two actuations of the lock to open the front hood when starting from the primary closed position. The known motor vehicle lock (EP 2 820 214 B1) comprises a trigger lever that is arranged on the actuation lever, wherein the trigger lever lifts the pawl from the secondary blocking position.

However, in the known solution, the dimensioning of the actuation lever and the additional trigger lever is limited when the force required for actuation is to be kept low.

It is, therefore, the object of various embodiments to provide a motor vehicle lock with a double-pull functionality, which has a more robust configuration of the actuation lever while requiring low opening forces.

The above-noted problem is solved for a motor vehicle lock with the features as described herein.

It is proposed that the motor vehicle lock comprises a trigger element that is configured separately from the actuation lever, which trigger element is brought into contact to the actuation lever in the actuation of the actuation lever when the pawl is in the secondary blocking position, with the actuation lever lifting the pawl to the release position via the trigger element.

It has been realized that the separate configuration of trigger element and actuation lever allows for a more robust design of the trigger element in general, while the layout of the actuation lever may be optimized for low opening forces. The trigger element may perform a transmission of opening forces between actuation lever and pawl. As the trigger element and the actuation lever are at least partially operating independently, the transmission may be configured to reduce the opening forces further.

In various embodiments, the trigger element is configured as pivotable trigger lever. When the trigger lever axis is arranged on the pawl, a compact arrangement of the detent mechanism is possible. Alternatively, the trigger element may be configured separately from the pawl, allowing for a robust layout of the trigger element and the pawl.

In various embodiments, the actuation of the actuation lever has a predefined reach being transmitted to the pawl. The transmission of the reach may be extended by the trigger element, which leads to a particularly simple layout of the motor vehicle lock. When providing stop elements for the actuation lever, there is an additional protection against an undesired opening of the lock with a single actuation starting from the primary locked position.

In various embodiments, the pawl comprises a primary actuation surface and a secondary actuation surface that correspond to different actuations. In particular, the actuation lever acts on the primary actuation surface and the trigger element acts on secondary actuation surface, such that the actuation surfaces can be specifically configured for the requirements of each actuation.

In various embodiments, the trigger element is pretensioned against a contact element of the pawl and is lifted by the actuation lever during actuation from the primary blocking position. The trigger element, therefore, acts similar to a ratchet during actuation.

In various embodiments, the pawl comprises primary and secondary blocking surfaces to block the catch by contact to a catch blocking surface. Therefore, the pawl may have a more robust design while the trigger element allows for an opening of the motor vehicle lock with reduced forces.

In various embodiments, the actuation lever lifts the pawl from the primary blocking position such that the catch is released from the primary closed position and that the catch drives the pawl to the secondary blocking position. Hence, it is guaranteed that the secondary blocking position is assumed by the pawl before the catch reaches the open position, avoiding an opening of the lock with a single actuation. The pawl may be lifted into an intermediate position between the primary blocking position and the secondary blocking position according to some embodiments.

An additional protection against an undesired opening of the motor vehicle lock, in particular when the motor vehicle is in motion, is provided in various embodiments, with the catch comprising a safety hook contour for holding a striker.

Further configurations of the actuation lever are also provided herein.

The problem indicated above is further solved by a motor vehicle according to some embodiments. The motor vehicle comprises a closure element, such as a motor vehicle front hood, with a striker and a motor vehicle lock as noted above arranged for a holding engagement to the striker. The actuation lever may be mechanically coupled by means of a mechanical actuation drive train to an actuation handle arranged in the interior of the motor vehicle. The arrangement of the actuation handle in the interior is particularly advantageous in combination with the above-mentioned double-pull functionality. All explanations given with respect to the motor vehicle lock noted above are fully applicable to the motor vehicle.

Various embodiments provide a motor vehicle lock, such as for a motor vehicle front hood, the motor vehicle lock comprising a detent mechanism with a catch and a pawl, wherein the catch is pivotable between an open position, a primary closed position and a secondary closed position, which is situated between the open position and the primary closed position, wherein the pawl is pivotable between a primary blocking position, in which the pawl may block the catch in the primary closed position, a secondary blocking position, in which the pawl may block the catch in the secondary closed position, and a release position to release the catch, wherein the motor vehicle lock comprises an actuation lever, which actuation, when the pawl is in the primary blocking position, leads to the actuation lever lifting the pawl such that the catch is released from the primary closed position and the pawl reaches the secondary blocking position to block the catch in the secondary closed position, and which actuation, when the pawl is in the secondary blocking position, leads to the actuation lever lifting the pawl to the release position, wherein the motor vehicle lock comprises a trigger element that is configured separately from the actuation lever, which trigger element is brought into contact to the actuation lever in the actuation of the actuation lever when the pawl is in the secondary blocking position, with the actuation lever lifting the pawl to the release position via the trigger element.

In various embodiments, the trigger element is configured as a trigger lever pivotable around a trigger lever axis. In some embodiments, the trigger lever axis is arranged on the pawl. In some embodiments, the trigger lever axis is arranged parallel to, in particular, coincides with, the pawl axis.

In various embodiments, the trigger element is configured separately from the pawl. In some embodiments, the trigger lever axis is configured separately from the pawl. In some embodiments, the trigger lever axis is arranged parallel to the actuation lever axis.

In various embodiments, the actuation of the actuation lever has a predefined reach that is independent of the position of the pawl, that the reach is transmitted to the pawl during actuation into a lifting motion of the pawl and that the trigger element extends the lifting motion of the pawl when the pawl is in the secondary blocking position. In some embodiments, the actuation comprises a pivoting movement of the actuation lever.

In various embodiments, the actuation of the actuation lever comprises an actuation stroke and a return stroke, that the difference between the respective end positions of the actuation lever in the actuation stroke and the return stroke predefines the reach of the actuation. In some embodiments, the motor vehicle lock comprises a stop element for the actuation lever at least at one of the end positions.

In various embodiments, the pawl comprises a primary actuation surface and a secondary actuation surface. In some embodiments, spaced apart from the primary actuation surface, that the actuation lever, when the pawl is in the primary blocking position, lifts the pawl by contact between the actuation lever and the primary actuation surface, and that the actuation lever, when the pawl is in the secondary blocking position, lifts the pawl by forcing the trigger element against the secondary actuation surface.

In various embodiments, the trigger element is pretensioned against a contact element of the pawl, that the actuation of the actuation lever, when the pawl is in the primary blocking position, such as the return stroke, leads to the trigger element being lifted from the contact element by the actuation lever. In some embodiments, the secondary actuation surface is arranged on the contact element of the pawl. In some embodiments, the contact element comprises a dampening element.

In various embodiments, the catch comprises a catch blocking surface, that the catch is blocked in the primary closed position by contact between the catch blocking surface and a primary blocking surface on the pawl in the primary blocking position, and that the catch is blocked in the secondary closed position by contact between the catch blocking surface and a secondary blocking surface on the pawl in the secondary blocking position.

In various embodiments, the primary blocking surface is spaced apart from the secondary blocking surface, and/or, that the catch blocking surface is identical for the primary closed position and the secondary closed position.

In various embodiments, the actuation of the actuation lever, when the pawl is in the primary blocking position, leads to the actuation lever lifting the pawl such that the catch is released from the primary closed position and that the catch, with the movement from the primary closed position to the secondary closed position, drives the pawl to the secondary blocking position.

In various embodiments, the actuation of the actuation lever, when the pawl is in the primary blocking position, leads to the actuation lever lifting the pawl into an intermediate position between the primary blocking position and the secondary blocking position and that the catch, with the movement from the primary closed position to the secondary closed position, drives the pawl from the intermediate position to the secondary blocking position.

In various embodiments, the catch comprises a safety hook contour for holding the striker and that the safety hook contour is arranged to receive the striker in the secondary closed position or in a safety position of the catch provided between the secondary closed position and the open position.

In various embodiments, the actuation lever comprises an actuation element that lifts the pawl, such as, that the actuation element comprises a dampening element.

In various embodiments, the motor vehicle lock comprises a connection arrangement for a Bowden cable for transmitting an actuation of the Bowden cable to an actuation of the actuation lever. In some embodiments, at least part of the connection arrangement, such as a receptable of an inner cable of the Bowden cable, is provided on the actuation lever.

Various embodiments provide a motor vehicle comprising a closure, such as a motor vehicle front hood, with a striker and a motor vehicle lock according to the disclosure arranged for a holding engagement to the striker. In some embodiments, the actuation lever is mechanically coupled by means of a mechanical actuation drive train to an actuation handle arranged in the interior of the motor vehicle.

### BRIEF DESCRIPTION OF THE DRAWINGS

In the following, various embodiments are explained with respect to the drawings. In the drawings,

FIG. 1 shows a motor vehicle with the proposed motor vehicle lock,

FIG. 2 the motor vehicle lock according to FIG. 1 in an opening sequence a) with the catch in the primary closed position, b) in the actuation of the actuation lever, c) with the catch in the secondary closed position, d) in another actuation of the actuation lever, and e) with the catch in the open position,

FIG. 3 a second configuration of the proposed motor vehicle lock in an opening sequence a) with the catch in the primary closed position, b) in the actuation of the actuation lever, c) with the catch in the secondary closed position, d) in another actuation of the actuation lever, and e) with the catch in the open position.

### DETAILED DESCRIPTION

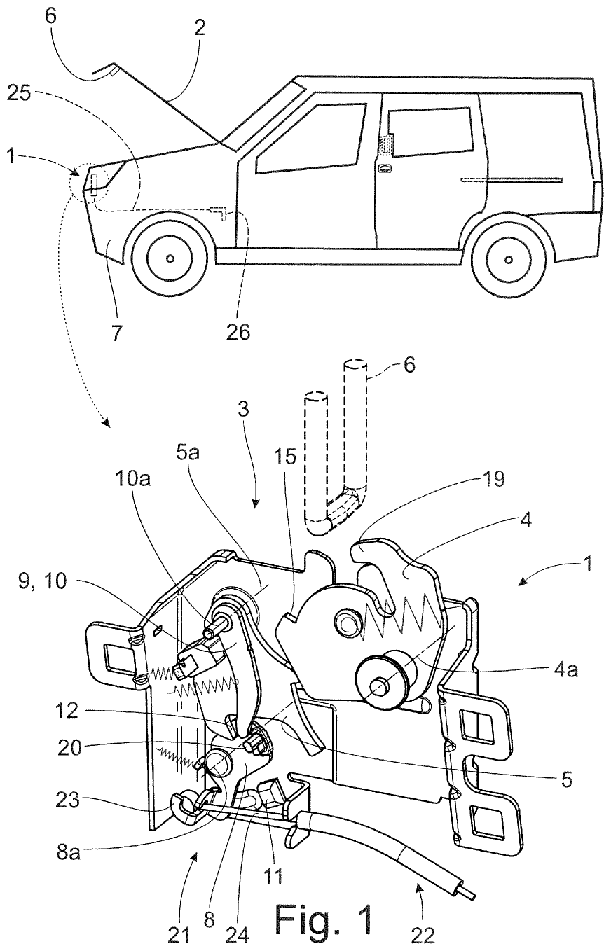

The proposed motor vehicle lock 1 may be assigned to any kind of closing element of a motor vehicle. Insofar, reference is made to the introductory part of the specification. As shown in FIG. 1, in some embodiments, the motor vehicle lock 1 is assigned to a motor vehicle front hood 2.

The motor vehicle lock 1 comprises a detent mechanism 3 with a catch 4 and a pawl 5, which interact with each other as will be explained.

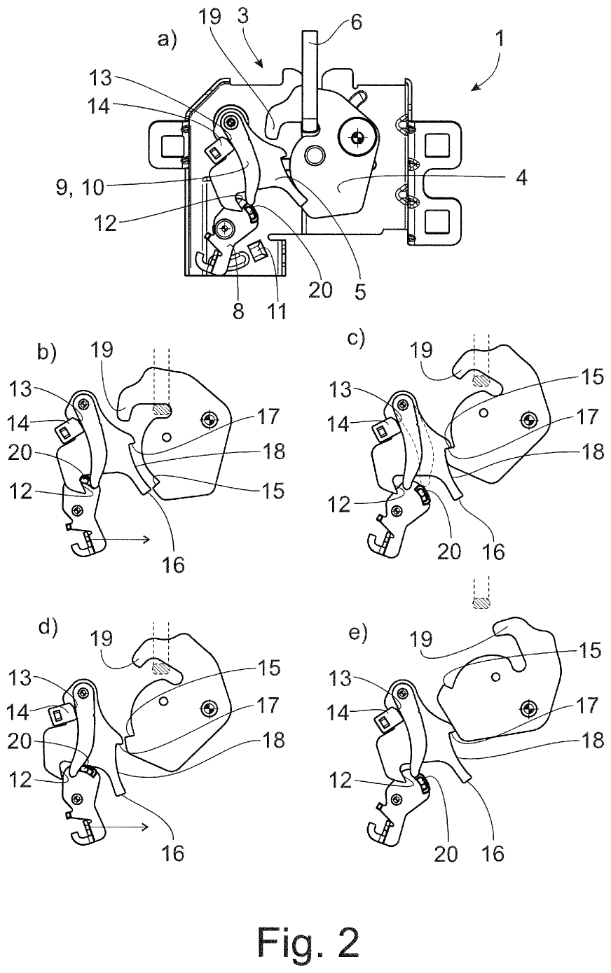

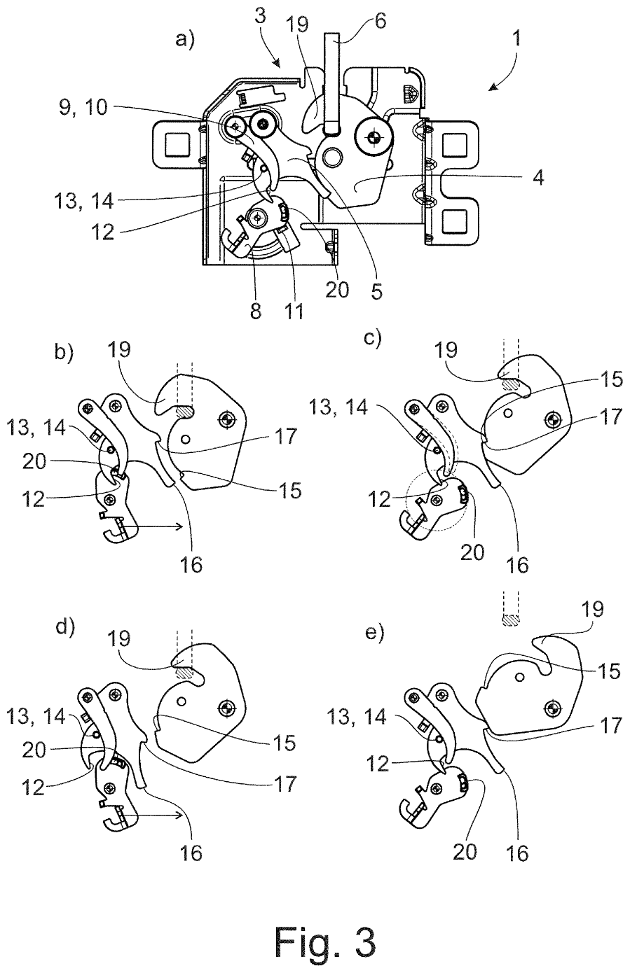

The catch 4 is pivotable, here around catch axis 4a, between an open position (FIGS. 2e), 3e)), a primary closed position (FIGS. 2a), 3a)) and a secondary closed position (FIGS. 2c), 3c)), which is situated between the open position and the primary closed position. In each of the closed positions, the catch 4 may be in holding engagement with a lock striker 6. In some embodiments, the motor vehicle lock 1 is arranged at the body 7 of the motor vehicle, while the lock striker 6 is arranged at a closing element of the motor vehicle, here at the motor vehicle front hood 2. A vice versa arrangement is possible.

The pawl 5 is pivotable, here around pawl axis 5a, between a primary blocking position (FIGS. 2a), 3a)), in which the pawl 5 may block the catch 4 in the primary closed position, and a secondary blocking position (FIGS. 2c), 3c)), in which the pawl 5 may block the catch 4 in the secondary closed position. The pawl 5 is also pivotable to a release position to release the catch 4 as shown in FIGS. 2e), 3e), such that the catch 4 may move into its open direction freely from the pawl 5. While the pawl 5 is illustrated in the Figures in a configuration as a single pivotable element of the detent mechanism 3, it is also possible that the pawl 5 comprises an arrangement of multiple pawl elements such as a primary pawl and a secondary pawl that provide an interaction with the catch 4.

The motor vehicle lock 1 comprises an actuation lever 8, which actuation leads to the actuation lever 8 lifting the pawl 5. The effect of the actuation on the pawl 5 depends on the blocking state of the pawl 5 when the actuation is performed. The actuation, when the pawl 5 is in the primary blocking position, leads to the actuation lever 8 lifting the pawl such that the catch 4 is released from the primary closed position and the pawl 5 reaches the secondary blocking position to block the catch 4 in the secondary closed position (FIG. 2a) to c), FIG. 3a) to c)). The actuation, when the pawl 5 is in the secondary blocking position, leads to the actuation lever 8 lifting the pawl 5 to the release position (FIG. 2c) to d), FIG. 3c) to d)).

Hence, starting from the primary closed position shown in FIGS. 2a), 3a), two actuations, such as two consecutive actuations, of the actuation lever 8 are required to open the motor vehicle lock 1 by bringing the catch 4 into the open position to release the striker 6 as shown in FIGS. 2e), 3e). That is, after a first actuation the pawl 5 reaches the secondary blocking position and still blocks the catch 4 in the secondary closed position. In particular, the pawl 5 does not fully reach the release position with the first actuation. Only after a second actuation, the release position is reached by the pawl 5 and the catch 4 may move into its open direction freely from the pawl 5.

In the figures, the opening direction of the catch 4 is the clockwise direction, while the closing direction of the catch 4 is the counter-clockwise direction. The lifting direction of the pawl 5 is the clockwise direction. The initial actuation of the actuation lever 8 comprises a rotation in the counter-clockwise direction.

In some embodiments, the motor vehicle lock 1 comprises a trigger element 9 that is configured separately from the actuation lever 8, which trigger element 9 is brought into contact to the actuation lever 8 in the actuation of the actuation lever 8 when the pawl 5 is in the secondary blocking position, with the actuation lever 8 lifting the pawl 5 to the release position via the trigger element 9 (FIGS. 2d), 3d)).

Referring again to a first and second actuation starting from the primary closed position shown in FIGS. 2a), 3a), in the second actuation, the trigger element 9 is mechanically coupled in between actuation lever 8 and pawl 5 causing the pawl 5 being lifted into the release position (FIGS. 2d), 3d)).

That the trigger element 9 is “configured separately” from the actuation lever 8 means that the trigger element 9 is configured to perform at least a partial movement independent of the actuation lever 8. Hence, the position of the trigger element 9 is at least partially independent of the position of the actuation lever 8. In particular, trigger element 9 and actuation lever are spaced apart from each other and are only brought in contact with each other for actuation.

While it is possible that the trigger element 9, for example, performs a translatory movement in an actuation, here the trigger element 9 is configured as a trigger lever 10 pivotable around a trigger lever axis 10a, performing a pivoting movement for actuation. In the Figures, the actuation direction of the trigger lever 10 is the clockwise direction.

According to FIGS. 1 and 2, the trigger lever axis 10a can be arranged on the pawl 5. In some embodiments, the trigger lever axis 10a is arranged parallel to the pivot axis of the pawl 5, here the pawl axis 5a. In principle, the trigger lever 10 may be arranged on the pawl 5 offset from the pawl axis 5a, such that the position of the trigger lever 10 is dependent on the position of the pawl 5 in that the trigger lever axis 10a is shifted by a rotation of the pawl 5. As shown in FIGS. 1 and 2, the trigger lever axis 10a may coincide with the pivot axis of the pawl, here the pawl axis 5a. The trigger lever 10 may therefore be also at least partially rotated independently of the position of the pawl 5.

An alternative arrangement of trigger element 9 and pawl 5 is shown in FIG. 3, wherein the trigger element 9 is configured separately from the pawl 5, wherein the trigger lever axis 10a can be configured separately from the pawl 5. Here, the trigger element 9 is configured as trigger lever 10 that is spaced apart from the pawl 5, which may provide for a more robust layout of trigger element 9 and pawl 5. In some embodiments, the trigger lever axis 10a is arranged parallel to an actuation lever axis 8a to enable an efficient transmission of the actuation. In some embodiments, catch axis 4a, pawl axis 5a, trigger lever axis 10a and actuation lever axis 8a are parallel to each other, respectively.

In some embodiments, the actuation lever 8 has a predefined reach that is independent of the position of the pawl 5. During an actuation, the actuation lever 8 regularly performs substantially the same motion. In the actuation, the movement along the reach is transmitted to the pawl 5 into a lifting motion of the pawl 5. As can be seen from FIGS. 2d), 3d), the trigger lever 10 extends the transmission into the lifting motion of the pawl 5 when the pawl 5 is in the secondary blocking position. Here, the reach of the actuation lever 8 is not sufficient to lift the pawl 5 into the release position starting from the primary blocked position (FIGS. 2b), 3b)). The additional transmission by the trigger lever 10 starting from the secondary blocking position, however, enables the actuation to lift the pawl 5 into the release position (FIGS. 2d), 3d)).

As mentioned above, in some embodiments, the actuation comprises a pivoting movement of the actuation lever 10, here around actuation lever axis 10a. The reach may therefore be defined by the angular end positions of the actuation lever 10 in the pivoting movement.

Further, the actuation of the actuation lever 10 can comprise an actuation stroke and a return stroke. The actuation stroke represents the movement of the actuation lever 10 from an initial position to a deflected position. The return stroke represents the movement of the actuation lever 10 from the deflected position to the initial position after the actuation stroke. The difference between the respective end positions of the actuation lever 10 in the actuation stroke and the return stroke predefine the reach of the actuation. As can be seen from FIGS. 1, 2a), 3a), the motor vehicle lock may comprise a stop element 11 for the actuation lever at least at one of the end positions, here at the end position of the actuation stroke. The stop element 11 ensures that the actuation lever 10 does not exceed the end position, ensuring that the pawl 5 cannot be lifted from the primary blocking position to the release position with a single actuation. In some embodiments, the stop element 11 may comprise a dampening element as illustrated in FIG. 3a) to reduce noise generation when the actuation lever 10 reaches the stop element 11.

Here, the pawl 5 comprises a primary actuation surface 12 and a secondary actuation surface 13, which can be spaced apart from the primary actuation surface 12. The actuation surfaces are the surfaces that come into contact with other elements of in the actuation, here with the actuation lever 8 and the trigger element 9. The actuation lever 8, when the pawl 5 is in the primary blocking position, lifts the pawl 5 by contact between the actuation lever 8 and the primary actuation surface 12 (FIGS. 2b), 3b)). The actuation lever 8, when the pawl 5 is in the secondary blocking position, lifts the pawl 5 by forcing the trigger element 9 against the secondary actuation surface 13 (FIGS. 2d), 3d)). Primary actuation surface 12 and secondary actuation surface 13 may therefore be configured for the specific requirements in each actuation.

As indicated in FIG. 1, catch 4, pawl 5, actuation lever 8 and trigger element 9 may be pretensioned, for example by means of spring elements. Specifically, the trigger element 9 is pretensioned against a contact element 14 of the pawl 5. The actuation of the actuation lever 8, when the pawl 5 is in the primary blocking position, such as the return stroke, leads to the trigger element 9 being lifted from the contact element 14 by the actuation lever 8. The trigger element 9 therefore performs a movement similar to a ratchet movement, with the dashed line in FIGS. 2c), 3c) illustrating the lifted position of the trigger element 9. In some embodiments, the secondary actuation surface 13 is arranged on the contact element 14 of the pawl 5. The contact element 14 may also comprise a dampening element, as shown in FIGS. 1 and 2, in particular, to reduce noise generation. Alternatively, as in the embodiment shown in FIG. 3, the contact element 14 comprises a gliding surface as secondary actuation surface 13, for example, a metallic surface and/or a surface with a friction-reducing coating.

In some embodiments, the catch 4 comprises a catch blocking surface 15 and the catch 4 is blocked in the primary closed position by contact between the catch blocking surface 15 and a primary blocking surface 16 on the pawl 5 in the primary blocking position (FIGS. 2a), 3a)). The catch 4 is blocked in the secondary closed position by contact between the catch blocking surface 15 and a secondary blocking surface 17 on the pawl 5 in the secondary blocking position (FIGS. 2c), 3c)). The respective blocking surfaces are the surfaces that come into contact in the blocking positions of the pawl 5. Here, the primary blocking surface 16 is spaced apart from the secondary blocking surface 17 in the sense that the primary blocking surface 16 and the secondary blocking surface 17 do not overlap. This allows for a particularly robust layout of the pawl 5. Further, the catch blocking surface 15 is identical for the primary closed position and the secondary closed position, also allowing for a compact layout of the catch 4.

As can be seen from FIG. 2b), c), the actuation of the actuation lever 8, when the pawl 5 is in the primary blocking position, may lead to the actuation lever 8 lifting the pawl 5 such that the catch 4 is released from the primary closed position and that the catch 4, with the movement from the primary closed position to the secondary closed position, drives the pawl 5 to the secondary blocking position. The pawl 5 is therefore not directly lifted into the secondary blocking position by the actuation lever 8 but is also partially lifted by the catch 4.

In particular, the pawl 5, as shown in FIG. 2b), comprises the primary blocking surface 16, wherein the pawl 5 is lifted by the actuation lever 8 such that the contact of primary blocking surface 16 and catch blocking surface 15 is lifted, initiating an opening movement of the catch 4. With the movement from the primary closed position to the secondary closed position, the edge of the catch blocking surface 15 slides along a contour 18 of the pawl 5 between the primary blocking surface 16 and the secondary blocking surface 17. The contour 18 is configured to move the pawl 5 into the secondary blocking position by contact to the catch 4, as shown in FIG. 2c).

Here, the actuation of the actuation lever 8, when the pawl 5 is in the primary blocking position, leads to the actuation lever 8 lifting the pawl into an intermediate position between the primary blocking position and the secondary blocking position, as shown in FIG. 2b). The catch 4, with the movement from the primary closed position to the secondary closed position, drives the pawl 5 from the intermediate position to the secondary blocking position. The risk that the pawl 5 is unintentionally lifted into the release position with a single actuation is therefore reduced further.

In some embodiments, the catch 4 comprises a safety hook contour 19 for holding the striker 6. The safety hook contour 19 is arranged to receive the striker 6 in the secondary closed position or in a safety position of the catch 4 provided between the secondary closed position and the open position. The safety hook contour 19 may for example avoid that the front hood 2 is opened when the motor vehicle is in motion. In particular, the motor vehicle lock 1 is configured such that, when the motor vehicle is stopped, the catch 4 may be released from the secondary closed position into the open position while avoiding a holding engagement of safety hook contour 19 and striker 6. For instance, on the one hand the catch 4 is pretensioned in such a manner that a contact of safety hook contour 19 and striker 6 is avoided while the front hood 2 is without load into an opening direction. The wind pressure on the front hood 2 when the motor vehicle is moving may, one the other hand, lead to a holding engagement between the safety hook contour 19 and the striker 6.

The actuation lever 8 may comprise an actuation element 20 that lifts the pawl 5, which actuation element 20 is illustrated as a protrusion of the actuation lever 8 in the Figures. In some embodiments, the actuation element 20 comprises a dampening element to avoid noise generation in the actuation.

In some embodiments, as shown in FIG. 1, the motor vehicle lock 1 comprises a connection arrangement 21 for a Bowden cable 22 for transmitting an actuation of the Bowden cable 22 to an actuation of the actuation lever 8. At least part of the connection arrangement 21, such as a receptacle 23 for an inner cable 24 of the Bowden cable 22 is provided on the actuation lever 8, enabling a particularly simple actuation of the motor vehicle lock 1.

According to various embodiments, a motor vehicle is provided. The motor vehicle is provided with a closure element, wherein, as already mentioned above, the closure element can be a motor vehicle front hood 2. A striker 6 and a motor vehicle lock 1 as noted above is provided, the motor vehicle lock 1 being arranged for a holding engagement to the striker 6. In some embodiments, as shown in FIG. 1, the actuation lever 8 is mechanically coupled by means of a mechanical actuation drive train 25 to an actuation handle 26 arranged in the interior of the motor vehicle.

1. A motor vehicle lock, comprising a detent mechanism with a catch and a pawl, wherein the catch is pivotable between an open position, a primary closed position and a secondary closed position, which is situated between the open position and the primary closed position,
wherein the pawl is pivotable between a primary blocking position, in which the pawl may block the catch in the primary closed position, a secondary blocking position, in which the pawl may block the catch in the secondary closed position, and a release position to release the catch,
wherein the motor vehicle lock comprises an actuation lever, which actuation, when the pawl is in the primary blocking position, leads to the actuation lever lifting the pawl such that the catch is released from the primary closed position and the pawl reaches the secondary blocking position to block the catch in the secondary closed position, and which actuation, when the pawl is in the secondary blocking position, leads to the actuation lever lifting the pawl to the release position,
wherein the motor vehicle lock comprises a trigger element that is configured separately from the actuation lever, which trigger element is brought into contact to the actuation lever in the actuation of the actuation lever when the pawl is in the secondary blocking position, with the actuation lever lifting the pawl to the release position via the trigger element.

2. The motor vehicle lock according to claim 1, wherein the trigger element is configured as a trigger lever pivotable around a trigger lever axis.

3. The motor vehicle lock according to claim 1, wherein the trigger element is configured separately from the pawl.

4. The motor vehicle lock according to claim 1, wherein the actuation of the actuation lever has a predefined reach that is independent of the position of the pawl, that the reach is transmitted to the pawl during actuation into a lifting motion of the pawl and that the trigger element extends the lifting motion of the pawl when the pawl is in the secondary blocking position.

5. The motor vehicle lock according to claim 1, wherein the actuation of the actuation lever comprises an actuation stroke and a return stroke, that the difference between the respective end positions of the actuation lever in the actuation stroke and the return stroke predefines the reach of the actuation.

6. The motor vehicle lock according to claim 1, wherein the pawl comprises a primary actuation surface and a secondary actuation surface, spaced apart from the primary actuation surface, that the actuation lever, when the pawl is in the primary blocking position, lifts the pawl by contact between the actuation lever and the primary actuation surface, and that the actuation lever, when the pawl is in the secondary blocking position, lifts the pawl by forcing the trigger element against the secondary actuation surface.

7. The motor vehicle lock according to claim 1, wherein the trigger element is pretensioned against a contact element of the pawl, that the actuation of the actuation lever, when the pawl is in the primary blocking position, preferably the return stroke, leads to the trigger element being lifted from the contact element by the actuation lever.

8. The motor vehicle lock according to claim 1, wherein the catch comprises a catch blocking surface, that the catch is blocked in the primary closed position by contact between the catch blocking surface and a primary blocking surface on the pawl in the primary blocking position, and that the catch is blocked in the secondary closed position by contact between the catch blocking surface and a secondary blocking surface on the pawl in the secondary blocking position.

9. The motor vehicle lock according to claim 8, wherein the primary blocking surface is spaced apart from the secondary blocking surface, and/or, that the catch blocking surface is identical for the primary closed position and the secondary closed position.

10. The motor vehicle lock according to claim 1, wherein the actuation of the actuation lever, when the pawl is in the primary blocking position, leads to the actuation lever lifting the pawl such that the catch is released from the primary closed position and that the catch, with the movement from the primary closed position to the secondary closed position, drives the pawl to the secondary blocking position.

11. The motor vehicle lock according to claim 1, wherein the actuation of the actuation lever, when the pawl is in the primary blocking position, leads to the actuation lever lifting the pawl into an intermediate position between the primary blocking position and the secondary blocking position and that the catch, with the movement from the primary closed position to the secondary closed position, drives the pawl from the intermediate position to the secondary blocking position.

12. The motor vehicle lock according to claim 1, wherein the catch comprises a safety hook contour for holding the striker and that the safety hook contour is arranged to receive the striker in the secondary closed position or in a safety position of the catch provided between the secondary closed position and the open position.

13. The motor vehicle lock according to claim 1, wherein the actuation lever comprises an actuation element that lifts the pawl, preferably, that the actuation element comprises a dampening element.

14. The motor vehicle lock according to claim 1, wherein the motor vehicle lock comprises a connection arrangement for a Bowden cable for transmitting an actuation of the Bowden cable to an actuation of the actuation lever.

15. A motor vehicle comprising a closure with a striker and a motor vehicle lock according to claim 1 arranged for a holding engagement to the striker.

16. The motor vehicle lock according to claim 2, wherein the trigger lever axis is arranged on the pawl and the trigger lever axis is arranged parallel to the pawl axis.

17. The motor vehicle lock according to claim 3, wherein the trigger lever axis is configured separately from the pawl and the trigger lever axis is arranged parallel to the actuation lever axis.

18. The motor vehicle lock according to claim 4, wherein the actuation comprises a pivoting movement of the actuation lever.

19. The motor vehicle lock according to claim 5, wherein the motor vehicle lock comprises a stop element for the actuation lever at least at one of the end positions.

20. The motor vehicle lock according to claim 7, wherein the secondary actuation surface is arranged on the contact element of the pawl, more preferably, that the contact element comprises a dampening element.
